(19) United States
(12) Patent Application Publication
(10) Pub. No.: US 2012/0107455 A1
(43) Pub. Date: May 3, 2012

(54) NON-FLOATING BEVERAGE INFUSER AND RIGID CLAMP

(76) Inventor: Paul Gregory Briggs, Buford, GA (US)

(21) Appl. No.: 12/938,884

(22) Filed: Nov. 3, 2010

(51) Int. Cl. B65B 29/02; A23L 2/56

(52) U.S. Cl. 426/78; 426/82; 426/431

(57) ABSTRACT

A non-floating beverage infuser and rigid clamp and method thereof comprising, in general, a suspension bag of flexible liquid permeable material that contains preselected flavor and/or gassing additives, an elongated member having a first and second end, the first end is affixed to the suspension bag, and a rigid clamp affixed to the second end of the elongated member to affix to the rim of a glass, and, thus, functions to provide deep submersible infusion of preselected flavor and gassing additives while preventing the upward flotation of the additives in a beverage.

### TECHNICAL FIELD

The disclosure relates generally to food products and more specifically it relates to beverages which are normally served cold and that are suitable for having preselected additives added or infused thereto before drinking, and still more particularly the invention relates to a deep submersible infusers of preselected flavor and gassing additives.

### BACKGROUND

Different beverages and packaging for beverages are known in the prior art. For example, there are different flavored of sodas, teas, beers, sports drinks, coffees, hot chocolate, and more recently vitamin and electrolyte waters. The different beverages are packaged in cans, bottles, and/or cartons.

It is known to prepare beverages, in particular tea, by using a liquid permeable container (tea bag) containing beverage extract (tea leaves). The tea beverage is prepared by placing the tea bag in hot water and allowing the tea bag to steep. The soluble base hot water extracts the water soluble tea, while the tea leaves remain in the tea bag. When sufficient steeping or extraction time has been achieved the tea bag is withdrawn from the cup and the tea beverage, free of any suspended solids such as tea leaves, is ready for drinking.

Various forms of disposable porous liquid permeable bags and multi-compartment bags for beverage infusion have been designed and various devices have also been designed to support such bags within a cup. For example, the simple string or strings attached to a beverage infusion bag such as tea or the like and is used to extract the tea bag without touching the wet tea bag. Moreover, devices such as sticks have been attach to tea bags in order to eliminate the need for a separate spoon to stir the beverage or to use it to withdraw the tea bag from an associated tea cup in place of the string.

Further, there are rigid devices made of metal or rigid plastic which includes a handle attached to a rigid strainer. One popular version of this apparatus is a pair of strainer tongs having tow arms interconnected by a flexible leaf spring. The beverage infuser material, such as tea, is placed in the strainer and submerged in a tea cup filled with hot water and allowed to steep—infuse the base liquid such as water with the tea flavoring agent. Such devices require cleaning and washing of the strainer after use, limiting there appeal to the user.

Additionally, handling devices for stirring and for hanging the stirring stick utilizing a hook to hold the tea bag to the sidewall of a vertical tea cup are known and are utilized to overcome the tendency of the stirring stick and dry non-gassing additive to float. However it is found in practice, that these known handling devices most often slide into the liquid and have to be dipped from the hot liquid by finger tip or tend to float up out of the hot water due to vertical lift from the buoyant tea. Moreover, tea bags themselves tend to rise up in the cup due to the tea being a light density and dry material.

Therefore, it is readily apparent that there is a recognizable unmet need for a non-floating beverage infuser and rigid clamp and method thereof, wherein such infuser provides deep submersible infusion of preselected flavor and gassing additives while preventing the upward flotation of the gassing additives in a beverage.

### BRIEF SUMMARY

Briefly described, in example embodiment, the present apparatus overcomes the above-mentioned disadvantage, and meets the recognized need for a non-floating beverage infuser and rigid clamp and method thereof comprising, in general, a suspension bag of flexible liquid permeable material that contains preselected flavor and/or gassing additives, an elongated member having a first and second end, the first end is affixed to the suspension bag, and a rigid clamp affixed to the second end of the elongated member to affix to the rim of a glass, and, thus, functions to provide deep submersible infusion of preselected flavor and gassing additives while preventing the upward flotation of the additives in a cold beverage.

According to its major aspects and broadly stated, the non-floating beverage infuser and rigid clamp and method thereof comprising, in general, a suspension bag of flexible porous liquid permeable material containing preselected flavor and/or gassing additives, the bag having side edges, an elongated stirring element having a first and second end, the first end is affixed to the suspension bag, a rigid clamp is affixed to the second end of the stirring element, the rigid clamp having an open end of a size sufficient to fit on the rim of a glass or cup, the rigid clamp having a spring of sufficient strength that functions to submerge the suspension bag containing gassing additives, and thus, producing a non-floating beverage infuser of gassing additives.

In a preferred embodiment, the non-floating beverage infuser for attachment to the rim of the beverage container, comprising an elongated member having a first end and a second end, a suspension bag made of flexible liquid permeable material, the suspension bag affixed to the second end of the elongated member, an elastic element having a first end affixed to the first end of the elongated member, and a pivot arm affixed to the second end of the elastic element, the pivot arm and the first end of the elongated member to form a clamp configured to grasp the rim of the beverage container.

In a further exemplary embodiment, the non-floating beverage infuser for attachment to the rim of the beverage container, comprising an elongated member having a first end and a second end, a suspension bag made of flexible liquid permeable material, the suspension bag affixed to the second end of the elongated member, an elastic element having a first end affixed to the first end of the elongated member, a pivot arm affixed to the second end of the elastic element, the pivot arm and the first end of the elongated member to form a clamp configured to grasp the rim of the beverage container, and a mesh container having a two part container configured to be opened and closed.

In still a further exemplary embodiment of the method of infusing a beverage in a rimmed beverage container with an infusible additive comprising the steps of providing an elongated member having a first end and a second end, a suspension bag made of flexible liquid permeable material, the suspension bag affixed to the second end of the elongated member, an elastic element having a first end affixed to the first end of the elongated member, and a pivot arm affixed to the second end of the elastic element, the pivot arm and the first end of the elongated member to form a clamp configured to grasp the rim of the beverage container, selecting an infusible additive, positioning the suspension bag within the beverage container, submerging the suspension bag and the elongated member into the beverage, gassing the beverage with the infusible additive, and clamping the clamp to the rim of the beverage container.

Accordingly, a feature of the non-floating beverage infuser is its ability to provide deep submersible infusion of preselected flavor and gassing additives.

Another feature of the non-floating beverage infuser is its ability to function as a stirring stick to evenly distribute the flavor and gassing additives contained in the suspension bag.

Still another feature of the non-floating beverage infuser is its ability to provide a rigid attachment means sufficient in strength to maintain deep submersible infusion of the suspension bag containing gassing additives.

Yet another feature of the non-floating beverage infuser is its ability to provide a simple and serviceable deep submersible infuser capable preventing the flotation of the suspension bag containing gassing additives.

Yet another feature of the non-floating beverage infuser is its ability to provide a reusable stirring element having a second end that enables the interchanging of suspension bags that contain various preselected flavor and gassing additives.

Yet another feature of the non-floating beverage infuser is its ability to provide a reusable stirring element having a second end with an attachment means sufficient to clasp the suspension bag containing gassing additives and having sufficient strength to hold the bag submersed.

Yet another feature of the non-floating beverage infuser is its ability to provide suspension bags apparatus which will remain fully immersed in the infusion liquid and resist any tendency to float due to the gassing additives held within the suspension bag.

Yet another feature of the non-floating beverage infuser is its ability to provide a clamp for removable support of the beverage infuser.

Yet another feature of the non-floating beverage infuser is its ability to infuse gassing additives such as dry and fresh hops or carbonation tablets.

Yet another feature of the non-floating beverage infuser is its ability to provide a preselected flavor and gassing additives to a cold beverage.

These and other features of the non-floating beverage infuser will become more apparent to one skilled in the art from the following Detailed Description of the Embodiments and Claims when read in light of the accompanying drawing Figures.

### BRIEF DESCRIPTION OF THE DRAWINGS

The present non-floating beverage infuser will be better understood by reading the Detailed Description of the embodiments with reference to the accompanying drawing figures, in which like reference numerals denote similar structure and refer to like elements throughout, and in which:

FIG. 1A is a side view of an example embodiment of a non-floating beverage infuser wherein the suspension bag is affixed to the elongated member at the suspension bag's side edge;

FIG. 1B is a side view of an example embodiment of a non-floating beverage infuser wherein the suspension bag is a clam shell mesh container;

FIG. 1C is a side view of an example embodiment of a non-floating beverage infuser wherein the second end of the elongated element is forked;

FIG. 1D is a side view of an example embodiment of a non-floating beverage infuser wherein the second end of the elongated element is a clamp affixed to the elongated element at the suspension bag's top edge;

FIG. 2A is a cross-sectional view of an example embodiment of a cup with the embodiment of FIG. 1A-D positioned therein;

FIG. 2B is a cross-sectional view of an example embodiment of a stem glass with the embodiment of FIG. 1A-D positioned therein;

FIG. 2C is a cross-sectional view of an example embodiment of a pint glass with the embodiment of FIG. 1A-D positioned therein; and

FIG. 3 is a flow diagram of a method of carbonating or gassing a beverage.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

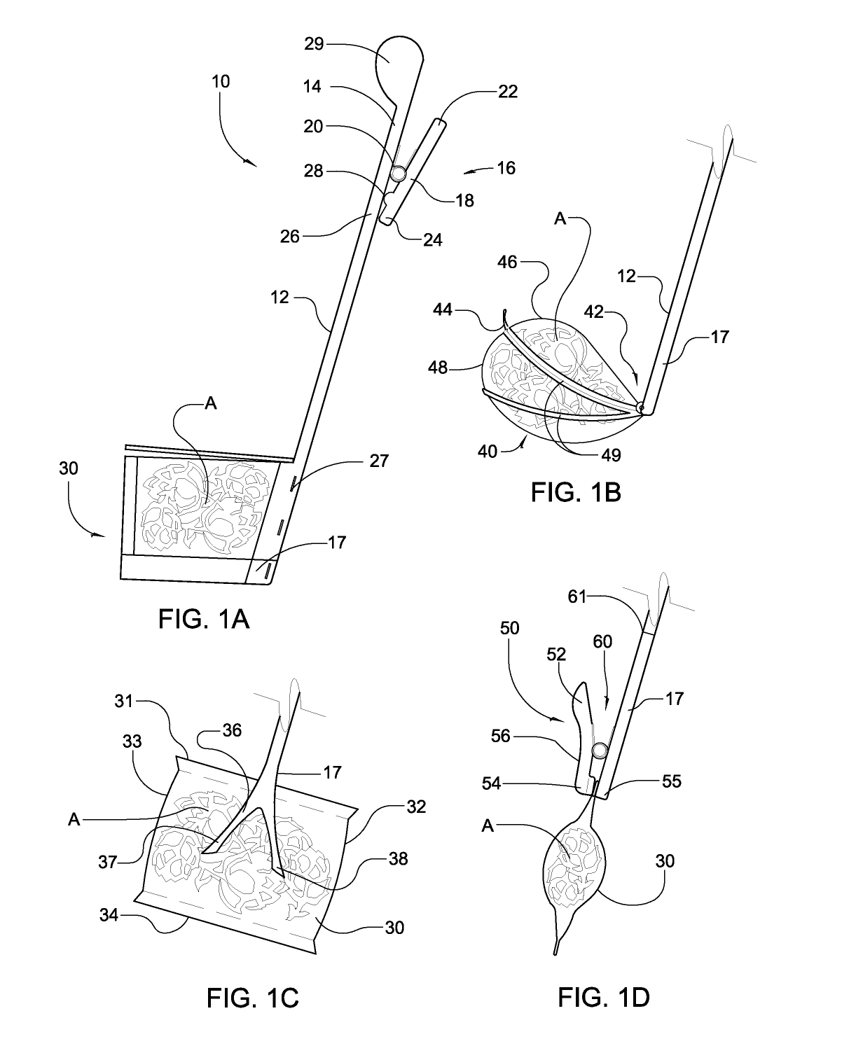

In describing the exemplary embodiments of the present disclosure, as illustrated in FIGS. 1-3 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

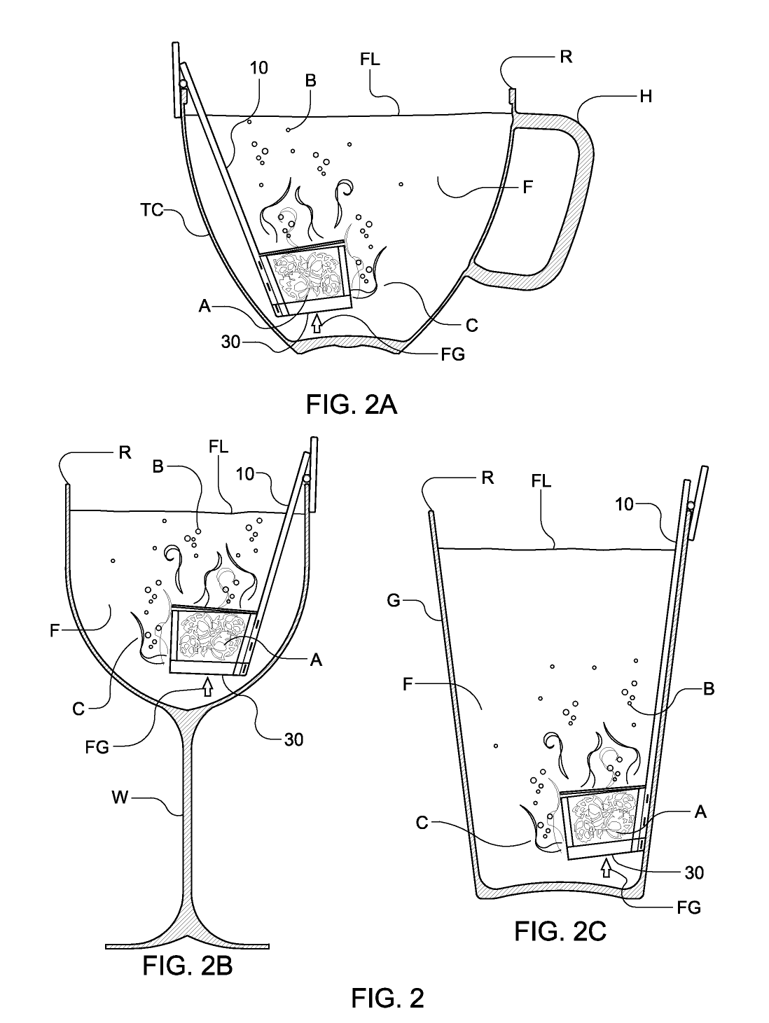

Referring now to FIG. 1, by way of example, and not limitation, there is illustrated side views of non-floating beverage infuser 10. Specifically, in FIG. 1A, non-floating beverage infuser 10, preferably comprises elongated element such as elongated member 12 having first end 14 and second end 17. Elongated member 12 is preferably formed of a suitable rigid material, such as wood, plastic, metal, rubber, foam, or the like, capable of providing structure, and beverage stirring capability to non-floating beverage infuser 10. Preferably, the material includes other suitable characteristics, such as durability, water-resistance, tastelessness, insoluble, light weight, heat-resistance, chemical inertness, oxidation resistance, ease of workability, or other beneficial characteristic understood by one skilled in the art. Moreover, elongated member 12 maybe configured as a stick, tube, rod, or other elongated configuration capable of providing deep submersible infusion in a beverage container such as glass G (shown in FIG. 2). Elongated member 12 may have a length between approximately two and approximately ten inches; more preferably between approximately three and approximately seven inches; and most preferably between approximately four and approximately five inches. Other lengths are contemplated herein depending on the depth of the fluid or liquid.

First end 14 preferably includes a clamping element such as clamp 16 capable of providing sufficient attachment force to removably retain non-floating beverage infuser 10 in a fixed position relative to glass G (shown in FIG. 2). Preferably, clamp 16 comprises first end 14 of elongated member 12, pivot arm 18 and an elastic element or biasing element used to store mechanical energy such as torsion spring 20 positioned there between. Pivot arm 18 is preferably formed of the same material as elongated member 12; however, it is contemplated that other suitable materials set forth above may be utilized. Pivot arm 18 further includes first end 22 and second end 24. First end 22 is preferably configured of sufficient length to enable compression of first end 22 of pivot arm 18 toward first end 14 of elongated member 12 by placing first end 22 of pivot arm 18 and end 14 of elongated member 12 between a user's thumb and finger. Second end 24 is preferably configured of sufficient length to enable an open end between second end 24 of pivot arm 18 and midpoint 26 of elongated member 12 to be of a size sufficient to fit around rim R of beverage container such as glass G (as shown in FIG. 2). One end of torsion spring 20 is preferably affixed to first end 14 of elongated member 12 and the other end of torsion spring 20 is preferably affixed is preferably includes first end

It should be recognized that torsion spring 20 may be configured using any suitable mechanical biasing element understood by one skilled in the art.

It is contemplated in an alternate embodiment that clamp 16 could be configured as a clasp, clamp, latch, or other fastener capable of holding first end 14 of elongated member 12 to the rim R of glass G (as shown in FIG. 2). Further, it is contemplated in an alternate embodiment that clamp 16 may include stationary arm opposite pivot arm 18 in contrast to utilizing first end 14 of elongated member and alternatively stationary arm would be affixed to first end 14 of elongated member 12 by any suitable attachment, such as heat seal, edible or non toxic adhesive, friction fit, rubber band, wire tie, tongue and groove, a slidable collar affixed around elongated member or in any other suitable manner understood by one skilled in the art.

Torsion spring 20 is preferably capable of providing sufficient twisting force to pivotably retain pivot arm 18 with respect to first end 14 of elongated member 12. Torsion spring 20 is preferably attached to the interior surface of pivot arm 18 and first end 14 of elongated member 12, but may alternatively be disposed within pivot arm 18 and first end 14 of elongated member 12 and further enables second end 24 of pivot arm 18 and midpoint 26 of elongated member 12 to spring open and closed, thus providing a gripping force there between. Torsion spring 20 is preferably formed of a suitable material, such as stainless steel or other shape memory material having suitable characteristics, such as durability, water-resistance, tastelessness and the like.

Further, midpoint 26 of elongated member 12 may include a bump or half sphere 28 capable of gripping rim R of glass G (as shown in FIG. 2). Half sphere 28 is preferably affixed to the interior surface of midpoint 26 of elongated member 12 and is preferably formed of the same material as elongated member 12; however, it is contemplated that other suitable materials set forth above may be utilized.

Still further, first end 14 of elongated member 12 may include a finger graspable tab such as tab 29 capable of being grasped between a user's thumb and finger for positioning non-floating beverage infuser 10 in glass G, removing non-floating beverage infuser 10 from glass G (as shown in FIG. 2), and/or used as a stir stirring stick to evenly distribute the flavor and gassing additives contained in suspension bag 30. Moreover, finger graspable tab 29 is positioned away from first end 22 of pivot arm 18 first so as not to interfere with the pivotal movement of first end 22 of pivot arm 18 and is preferably formed of the same material as elongated member 12; however, it is contemplated that other suitable materials set forth above may be utilized. In addition, finger graspable tab 29 may be utilized to stir the fluid or beverage F contents held within glass G (as shown in FIG. 2) and alternatively may be configured as a removable end piece affixed to first end 14 of elongated member 12.

Furthermore, non-floating beverage infuser 10 preferably includes a porous flexible liquid permeable pouch such as suspension bag 30 capable of containing flavor and gassing additives A. Suspension bag 30 is preferably formed of a suitable material, such as porous paper, felt, fiber, plastic, flexible film plastic, or the like, which is permeable to fluid, and leaves no taste to fluid or beverage F, but retains beverage F flavor and gassing additives therein, such as, fresh hops, dry hops, fruit essence, coffee essence, vanilla, chocolate, other flavor extracts and the like, whether pellets, granulated, mulched or powder additives, and also including carbonation tablets and the like or combinations thereof for flavoring or gassing a beverage F.

Preferably, suspension bag 30 comprises sides or edges, including top edge 31, right side edge 32, left side edge 33, and bottom edge 34 arranged typically in a square configuration. Suspension bag 30, in general, is preferably formed as a tube and when filled with flavor and gassing additive A it is folded in half to form a U-shape with open ends coming together or pointing up and flavor and gassing additive A settling to the bottom of the saddle bag enclosure. Next, the two open ends of the tube are folded over one another and stapled (or any suitable attachment, such as heat seal, edible or non toxic adhesive or the like) to form a square container for flavor and gassing additive A, suspension bag 30.

It is contemplated herein that suspension bag 30 may be configured as a single two edge pouch, single opening single edge pouch, multiple pouches, a draw string pouch, or the like.

It is further contemplated herein that suspension bag may be provided with an opening or slot on one edge located generally on an adjacent edge to where suspension bag 30 is affixed to second end 17 of elongated member 12 or in proximity to the top edge 31 and preferably configured for filling or refilling suspension bag 30 with flavor and gassing additive A.

It is recognized that suspension bag 30 may be formed and filled utilizing conventional processes, inexpensively produced, and the suspension bag 30 may be affixed to second end 17 of elongated member 12 or free of direct attachment.

Suspension bag 30 is preferably affixed to second end 17 by an attachment device, such as, a staple 27 capable of affixing one edge of suspension bag 30 to second end 17 of elongated member 12. It is contemplated herein that the attachment device herein may any suitable attachment, such as heat seal, edible or non toxic adhesive, friction fit, or in any other suitable manner.

It is further contemplated herein that clamp 16 may be slidably affixed to elongated member 12 enabling adjustable placement of along suspension bag 30 deep into glass G (as shown in FIG. 2). Clamp 16 may be frictionally held by tongue and groove, a slidable collar affixed around elongated member 12 or the like understood by one skilled in the art.

Referring now to FIG. 1B, there is illustrated a side view of non-floating beverage infuser 10 wherein suspension bag 30 is replaced by an exemplary embodiment clam shell configured mesh container 40. Mesh container 40 preferably includes a two part openable container such as first clam member 46 and second clam member 48 configured to form a two part concave container with edge 49 whereby first clam member 46 and second clam member 48 abut along edges 49 in a closed position to form mesh container 40. Moreover, first clam member 46 and second clam member 48 may be spaced apart via pivot member such as hinge 42 in an open position to allow insertion of flavor and gassing additive A into mesh container 40. Mesh container 40 is preferably affixed to second end 17 of elongated member 12. First and second clam members 46 and 48, respectively, are preferably formed of stainless steel; however other suitable materials may be utilized having characteristics, such as durability, water-resistance, light weight, rust resistant, heat-resistance, sized to communicate additive A with beverage F while preventing additive A from flowing through mesh container 40, chemical inertness, oxidation resistance, ease of workability, or other beneficial characteristic understood by one skilled in the art. Hinge 42 is preferably positioned along edges 49 where first clam member 46 and second clam members 48 abut one another. Mesh container 40 preferably includes a locking arrangement such as latch 44 capable of providing sufficient retaining force to hold first clam member 46 and second clam members 48 in a closed container position. Moreover, hinge 42 is preferably positioned along edges 49 where first clam member 46 and second clam members 48 abut one another. In addition, hinge 42 may include any mechanical biasing element 22 similar to that of torsion spring 20.

It is contemplated herein that mesh container 40 may be configured as various shapes other than a two part clam configuration shown.

Referring now to FIG. 1C, there is illustrated a side view of non-floating beverage infuser 10 wherein second end of elongated member 12 is further configured having a split or branched end such as bifurcated end 36. Bifurcated end 36 preferably includes first prong 37 and second prong 38 configured to form a fork for poking suspension bag 30 to affix suspension bag 30 to second end 17 of elongated member 12. Preferably, bifurcated end 36 is utilized to penetrate and hook one side of suspension bag 30 between top edge 31, right side edge 32, left side edge 33, and bottom edge 34 and is utilized to affix suspension bag 30 to second end 17 of elongated member 12.

It is contemplated in this exemplary embodiment that first prong 37 and second prong 38 may be configured to touch one another or be positioned side-by-side and may be sprung apart to frictionally hold one side of suspension bag 30 inserted therebetween first prong 37 and second prong 38.

Referring now to FIG. 1D, there is illustrated a side view of non-floating beverage infuser 10 wherein second end 17 of elongated member 12 is further configured having a mechanical device with moving jaws such as second clamp 50. Clamp 50 is preferably capable of providing sufficient attachment force to removably affix suspension bag 30 thereto second end 17. Preferably, clamp 50 includes second pivot arm 56, gripping end 55 of second end 17 of elongated member 12, and a biasing or elastic element such as second torsion spring 60 positioned there between. Pivot arm 56 is preferably formed of the same material as elongated member 12; however, it is contemplated that other suitable materials set forth above may be utilized. Pivot arm 56 further comprises first end 52 and second end 54. First end 52 is preferably configured of sufficient length to enable compression of first end 52 of pivot arm 56 toward second end 17 of elongated member 12 by placing first end 52 of pivot arm 56 and second end 17 of elongated member 12 between a user's thumb and finger. Second end 54 is preferably configured of sufficient length to enable an open end between second end 54 of pivot arm 56 and gripping end 55 of second end 17 of elongated member 12 to be of a size sufficient to fit around one edge (top edge 31, right side edge 32, left side edge 33, or bottom edge 34) of suspension bag 30.

It should be recognized that torsion spring 60 (similar to torsion spring 20) may be configured using any suitable mechanical biasing element understood by one skilled in the art or as set forth in the description above for torsion spring 20, but rather for securing suspension bag 30 to second end 17 of elongated member 12.

Preferably clamp 50 is rotated or offset approximately ninety degrees from the position of clamp 16 in relation to elongated member 12 to position suspension bag 30 away from the sidewall of glass G (as shown in FIG. 2).

It is contemplated in this exemplary embodiment that clamp 50 and clamp 16 may be rotationally offset at any degree in relation to elongated member 12.

It is further contemplated in this exemplary embodiment that elongated member 12 may be configured in two pieces enabling a rotational frictional coupling or the like such as coupling element 61 between first end 14 and second end 17 of elongated member 12.

Referring now to FIG. 2, there is illustrated a cross-sectional view of various drinking apparatus with exemplary embodiment non-floating beverage infuser 10 inserted and submerged therein. Specifically, in FIG. 2A shown as a cross-sectional view of an example embodiment cup, non-floating beverage infuser 10 is shown inserted into tea or coffee cup TC. Preferably, clamp 16 is rigidly affixed to rim R of cup TC and capable of holding elongated member 12 and gassing suspension bag 30 in deep submersion below fluid line FG of beverage F. Non-floating beverage infuser 10 is preferably capable of maintaining the deep submersion position of suspension bag 30 in cup C while flavor and gassing additives A contained in suspension bag 30 release gas causing an additional upward flotation force FG inside suspension bag 30. Upward flotation force FG pulls or lifts suspension bag 30 toward fluid line FL creating the necessity of rigid clamp 16 to counter flotation force FG produced by flavor and gassing additives A.

Specifically, in FIG. 2B shown as a cross-sectional view of an example embodiment stem glass, wherein non-floating beverage infuser 10 is shown inserted into wine or stem glass W. Preferably, clamp 16 is rigidly affixed to rim R of stem glass W and capable of holding elongated member 12 and gassing suspension bag 30 in deep submersion below fluid line FG of beverage F. Non-floating beverage infuser 10 is preferably capable of maintaining the deep submersion position of suspension bag 30 in stem glass W while flavor and gassing additives A contained in suspension bag 30 release gas causing an additional upward flotation force FG inside suspension bag 30. Upward flotation force FG pulls or lifts suspension bag 30 toward fluid line FL creating the necessity of rigid clamp 16 to counter flotation force FG produced by flavor and gassing additives A.

Specifically, in FIG. 2C shown as a cross-sectional view of an example embodiment beer or pint glass G, wherein non-floating beverage infuser 10 is shown inserted into pint glass G. Preferably, clamp 16 is rigidly affixed to rim R of pint glass G and capable of holding elongated member 12 and gassing suspension bag 30 in deep submersion below fluid line FG of beverage F. Non-floating beverage infuser 10 is preferably capable of maintaining the deep submersion position of suspension bag 30 in pint glass G while flavor and gassing additives A contained in suspension bag 30 release gas causing an additional upward flotation force FG inside suspension bag 30. Upward flotation force FG pulls or lifts suspension bag 30 toward fluid line FL creating the necessity of rigid clamp 16 to counter flotation force FG produced by flavor and gassing additives A.

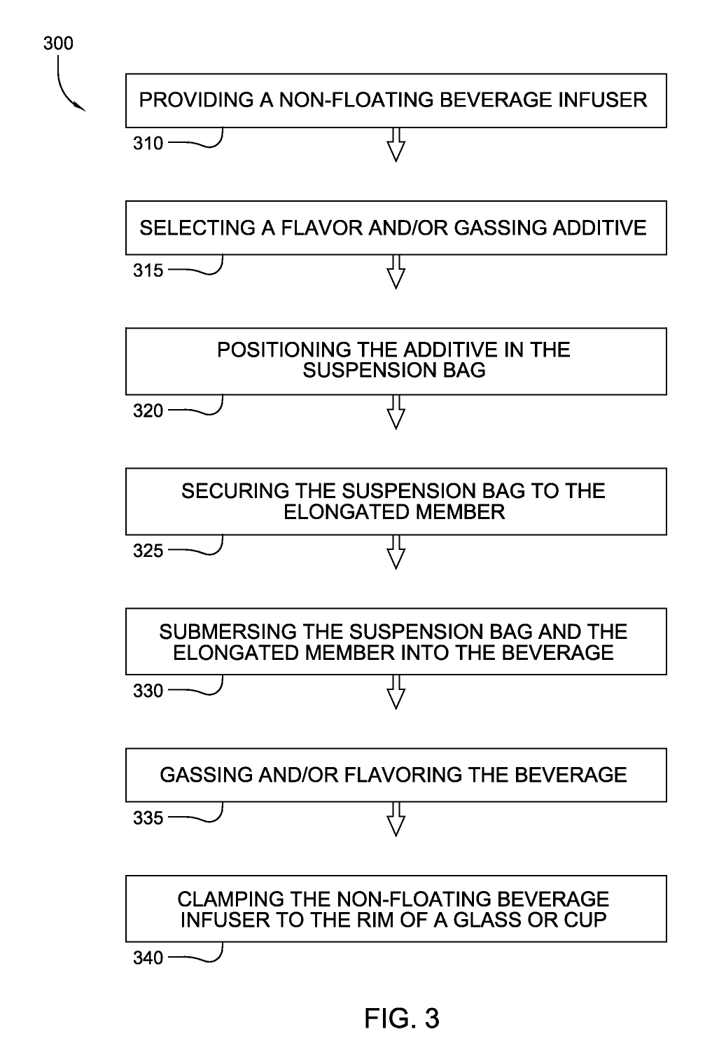

Referring now to FIG. 3, there is illustrated a flow diagram 300 of a method for carbonating or gassing a beverage. In block or step 310, providing non-floating beverage infuser 10, which comprises elongated member 12 having suspension bag 30 on one end and rigid clamp 16 on the other, as described above in FIGS. 1 and 2. In block or step 315, selecting infusible flavor and gassing additives A to add to beverage F. In block or step 320, placing flavor and gassing additives A into suspension bag 30 or mesh container 40. In block or step 325, securing suspension bag 30 to elongated member 12. In block or step 330, submersing suspension bag 30 or mesh container 40 and elongated member 12 into beverage F. In block or step 335, gassing and/or flavoring beverage F with selected flavor and/or gassing additives A. In block or step 340, clamping clamp 16 to rim R of pint glass G or cup C securing suspension bag 30 in deep submersion below fluid line FL of beverage F and further securing suspension bag 30 against upward flotation force FG produced by gassing additives A.

The foregoing description and drawings comprise illustrative embodiments of the present invention. Having thus described exemplary embodiments, it should be noted by those ordinarily skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains having the benefit of the teachings presented in the foregoing descriptions and the associated drawings. Although specific terms may be employed herein, they are used in a generic and descriptive sense only and not for purposes of limitation. Moreover, the present invention has been described in detail, it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

What is claimed is:

1. A non-floating beverage infuser for attachment to the rim of the beverage container, comprising:
an elongated member having a first end and a second end;
a suspension bag made of flexible liquid permeable material, said suspension bag affixed to said second end of said elongated member;
an elastic element having a first end affixed to said first end of said elongated member; and
a pivot arm affixed to said second end of said elastic element, said pivot arm and said first end of said elongated member to form a clamp configured to grasp the rim of the beverage container.

2. The non-floating beverage infuser of claim 1, wherein said clamp is affixed to the rim of the beverage container to secure said suspension bag in deep submersible infusion within the beverage container.

3. The non-floating beverage infuser of claim 1, wherein said suspension bag is positioned within the beverage container.

4. The non-floating beverage infuser of claim 1, wherein said suspension bag contains an infusible gassing substance.

5. The non-floating beverage infuser of claim 4, wherein said infusible gassing substance is selected from the group consisting of dry hops, fresh hops, carbonation tablets and combinations thereof.

6. The non-floating beverage infuser of claim 1, wherein said suspension bag contains an infusible flavor additive.

7. The non-floating beverage infuser of claim 6, wherein said infusible flavor additive is selected from the group consisting of fruit essence, coffee essence, vanilla, chocolate and combinations thereof.

8. The non-floating beverage infuser of claim 3, wherein the beverage container holds a cold beverage.

9. The non-floating beverage infuser of claim 2, wherein said clamp and said elongated member configured to prevent the upward flotation of said suspension bag.

10. The non-floating beverage infuser of claim 1, further comprises a finger tab configured to function as a stirring stick to evenly distribute said flavor and gassing additives contained in the suspension bag.

11. The non-floating beverage infuser of claim 1, wherein said second end of said elongated member further comprises a bifurcated end having a first prong and second prong configured to form a fork for poking said suspension bag.

12. The non-floating beverage infuser of claim 1, wherein said second end of said elongated member further comprises a second clamp configured to interchangeably grasp said suspension bag.

13. The non-floating beverage infuser of claim 12, wherein said second clamp further comprises a second elastic element having a first end affixed to said second end of said elongated member and a second pivot arm affixed to said second end of said elastic element.

14. A non-floating beverage infuser for attachment to the rim of the beverage container, comprising:
an elongated member having a first end and a second end;
a suspension bag made of flexible liquid permeable material, said suspension bag affixed to said second end of said elongated member;
an elastic element having a first end affixed to said first end of said elongated member;
a pivot arm affixed to said second end of said elastic element, said pivot arm and said first end of said elongated member to form a clamp configured to grasp the rim of the beverage container; and
a mesh container having a two part container configured to be opened and closed.

15. The non-floating beverage infuser of claim 14, wherein said clamp is affixed to the rim of the beverage container to secure said suspension bag in deep submersible infusion within the beverage container.

16. The non-floating beverage infuser of claim 14, wherein said mesh container is positioned within the beverage container.

17. The non-floating beverage infuser of claim 14, wherein said mesh container contains an infusible gassing substance.

18. The non-floating beverage infuser of claim 17, wherein said infusible gassing substance is selected from the group consisting of dry hops, fresh hops, carbonation tablets and combinations thereof.

19. The non-floating beverage infuser of claim 14, wherein said mesh container contains an infusible flavor additive.

20. The non-floating beverage infuser of claim 19, wherein said infusible flavor additive is selected from the group consisting of fruit essence, coffee essence, vanilla, chocolate and combinations thereof.

21. The non-floating beverage infuser of claim 15, wherein said clamp and said elongated member configured to prevent the upward flotation of said mesh container.

22. A method of infusing a beverage in a rimmed beverage container with an infusible additive comprising the steps of:
providing an elongated member having a first end and a second end, a suspension bag made of flexible liquid permeable material, said suspension bag affixed to said second end of said elongated member, an elastic element having a first end affixed to said first end of said elongated member, and a pivot arm affixed to said second end of said elastic element, said pivot arm and said first end of said elongated member to form a clamp configured to grasp the rim of the beverage container;
selecting an infusible additive;
positioning said suspension bag within the beverage container;
submerging said suspension bag and said elongated member into the beverage;
gassing the beverage with said infusible additive; and
clamping said clamp to the rim of the beverage container.
